(19) United States
(12) Patent Application Publication
(10) Pub. No.: US 2021/0090019 A1
(43) Pub. Date: Mar. 25, 2021

(54) METHOD AND SYSTEM FOR AN AUTOMATED DECISION ON SELECTION OF TRANSPORT VEHICLE FOR LONG-HAUL ROUTE

(71) Applicant: Camions Logistics Solutions Private Limited, New Delhi (IN)

(72) Inventors: Sumit SHARMA, North West Delhi (IN); Parag AGGARWAL, North East Delhi (IN); Naitik BAGHLA, Faridkot (IN)

(73) Assignee: Camions Logistics Solutions Private Limited, New Delhi (IN)

(21) Appl. No.: 16/810,759

(22) Filed: Mar. 5, 2020

(30) Foreign Application Priority Data
Sep. 19, 2019 (IN) 201911037808

(51) Int. Cl. G06Q 10/08; G06N 20/00

(52) U.S. Cl. CPC G06Q 10/0834; G06Q 10/0835; G06N 20/00

(57) ABSTRACT

The present disclosure provides a method, non-transitory computer-readable storage medium, and a vehicle tracking system for enabling an automated decision on selection of a plurality of transport vehicles for long haul route. The system receives a request for one or more transport vehicles for transportation on the long-haul route. The system fetches a second set of data. In addition, the system analyzes a first set of data and the second set of data. Further, the system determines one or more available vehicles from the plurality of transport vehicles. Furthermore, the system prioritizes the one or more available vehicles from the plurality of transport vehicles. Moreover, the system sends an allocation confirmation to one or more users for at least one selected vehicle from the one or more available vehicles. Also, the system notifies at least one vendor of one or more vendors for the transportation of the plurality of products.

### TECHNICAL FIELD

The present disclosure relates to the field of logistics, and in particular, relates to a method and system for an automated decision on selection of transport vehicle for long-haul route.

### INTRODUCTION

With the advent in technological advancements over the past few decades, there has been an exponential rise in the logistics industry. Efficient transportation systems are highly valuable for security, lowering expenses and maintenance. Numerous methods and devices have been developed for efficiently managing and selecting a vehicle for transportation of goods. The transportation vehicles are generally selected based on the availability of the vehicle. In addition, the available vehicle may not be compatible with a particular source and destination or a type of goods or products to be transported. The transportation vehicles may not reach the destination on time due to wrong selection of the vehicle. In addition, the wrong selection of the vehicle may affect the transportation cost severely. Further, selecting the appropriate vehicle for the transportation of goods on a long-haul route is essential for cost optimization and improved vehicle management.

### SUMMARY

In a first example, a computer-implemented method is provided. The computer-implemented method is configured to enable an automated decision on selection of a plurality of transport vehicles associated with one or more vendors for long haul route. The computer-implemented method includes a first step to receive a request for the one or more transport vehicles for transportation on the long-haul route. In addition, the computer-implemented method includes a second step to fetch a second set of data from a cloud platform. The second set of data is associated with the plurality of transport vehicles and one or more vendors. Further, the computer-implemented method includes a third step to analyze a first set of data and the second set of data. The first set of data and the second set of data are analyzed in real time. Furthermore, the computer-implemented method includes a fourth step to determine one or more available vehicles from the plurality of transport vehicles in real time. Moreover, the computer-implemented method includes a fifth step to prioritize the one or more available vehicles from the plurality of transport vehicles based on score card of the plurality of transport vehicles and the one or more vendors. Also, the computer-implemented method includes a sixth step to send an allocation confirmation to one or more users for at least one selected vehicle from the one or more available vehicles. Also, the computer-implemented method includes a seventh step to notify at least one vendor of the one or more vendors associated with the at least one selected vehicle from the plurality of transport vehicles for the transportation of the plurality of products on the long-haul route. In addition, the request for the one or more transport vehicles is based on the first set of data. The first set of data is received from the one or more users with the facilitation of one or more media devices. Further, the one or more available vehicles from the plurality of transport vehicles is determined with the facilitation of one or more machine learning algorithms in real time. Furthermore, the one or more available vehicles from the plurality of transport vehicles are prioritized with the facilitation of the one or more machine learning algorithms in real time. Furthermore, notification of the allocation confirmation associated with the at least one selected vehicle from the one or more available vehicles is displayed in real time on the one or more media devices. Moreover, the at least one vendor from the one or more vendors is notified on the one or more media devices.

In an embodiment of the present disclosure, the first set of data may include a type of products, type of truck required, number of products, pickup date, pickup time, pickup location, and drop location.

In an embodiment of the present disclosure, the second set of data may include technical parameters and general parameters associated with the plurality of transport vehicles and the one or more vendors.

In an embodiment of the present disclosure, the technical parameters may include fuel consumption of vehicle, vehicle health, load carrying capacity of vehicle, type of vehicle, length of vehicle, range of vehicle, and engine capacity of vehicle.

In an embodiment of the present disclosure, the general parameters may include vehicles on same route, current schedule, current availability, future availability on the requested date, current location, remaining distance, current estimated time of arrival, number of pitstops, duration of pitstops, distance between pickup location and destination point of previous trip of the current vehicles in transit.

In an embodiment of the present disclosure, the score card of the plurality of transport vehicles and the one or more vendors are determined based on the past services offered by the one or more vendors, interaction with the one or more vendors, commitment by the one or more vendors, condition of vehicles offered by the one or more vendors, cheating history of the one or more vendors and past profitability ratio on hiring the one or more vendors.

In an embodiment of the present disclosure, the computer-implemented method includes yet another step of alerting an administrator for selection of the at least one vendor of the one or more vendors associated with the at least one selected vehicle from the plurality of transport vehicles for the transportation of the plurality of products on the long-haul route. In addition, the administrator is notified on the one or more media devices.

In an embodiment of the present disclosure, the administrator modifies the selection of the at least one vendor of the one or more vendors associated with the at least one selected vehicle from the plurality of transport vehicles for the transportation of the plurality of products on the long-haul route.

In a second example, a computer system is provided. The computer system includes one or more processors, and a memory. The memory is coupled to the one or more processors. The memory stores instructions. The memory is executed by the one or more processors. The execution of the memory causes the one or more processors to perform a method to enable an automated decision on selection of a plurality of transport vehicles associated with one or more vendors for long haul route. The method includes a first step to receive a request for the one or more transport vehicles for transportation on the long-haul route. In addition, the method includes a second step to fetch a second set of data from a cloud platform. The second set of data is associated with the plurality of transport vehicles and one or more vendors. Further, the method includes a third step to analyze a first set of data and the second set of data. The first set of data and the second set of data are analyzed in real time. Furthermore, the method includes a fourth step to determine one or more available vehicles from the plurality of transport vehicles in real time. Moreover, the method includes a fifth step to prioritize the one or more available vehicles from the plurality of transport vehicles based on score card of the plurality of transport vehicles and the one or more vendors. Also, the method includes a sixth step to send an allocation confirmation to one or more users for at least one selected vehicle from the one or more available vehicles. Also, the method includes a seventh step to notify at least one vendor of the one or more vendors associated with the at least one selected vehicle from the plurality of transport vehicles for the transportation of the plurality of products on the long-haul route. In addition, the request for the one or more transport vehicles is based on the first set of data. The first set of data is received from the one or more users with the facilitation of one or more media devices. Further, the one or more available vehicles from the plurality of transport vehicles are determined with the facilitation of one or more machine learning algorithms in real time. Furthermore, the one or more available vehicles from the plurality of transport vehicles are prioritized with the facilitation of the one or more machine learning algorithms in real time. Furthermore, notification of the allocation confirmation associated with the at least one selected vehicle from the one or more available vehicles is displayed in real time on the one or more media devices. Moreover, the at least one vendor from the one or more vendors is notified on the one or more media devices.

In a third example, a non-transitory computer-readable storage medium is provided. The non-transitory computer-readable storage medium encodes computer executable instructions that, when executed by at least one processor, performs a method. The method is configured enable an automated decision on selection of a plurality of transport vehicles associated with one or more vendors for long haul route. The method includes a first step to receive a request for the one or more transport vehicles for transportation on the long-haul route. In addition, the method includes a second step to fetch a second set of data from a cloud platform. The second set of data is associated with the plurality of transport vehicles and one or more vendors. Further, the method includes a third step to analyze a first set of data and the second set of data. The first set of data and the second set of data is analyzed in real time. Furthermore, the method includes a fourth step to determine one or more available vehicles from the plurality of transport vehicles in real time. Moreover, the method includes a fifth step to prioritize the one or more available vehicles from the plurality of transport vehicles based on score card of the plurality of transport vehicles and the one or more vendors. Also, the method includes a sixth step to send an allocation confirmation to one or more users for at least one selected vehicle from the one or more available vehicles. Also, the method includes a seventh step to notify at least one vendor of the one or more vendors associated with the at least one selected vehicle from the plurality of transport vehicles for the transportation of the plurality of products on the long-haul route. In addition, the request for the one or more transport vehicles is based on the first set of data. The first set of data is received from the one or more users with the facilitation of one or more media devices. Further, the one or more available vehicles from the plurality of transport vehicles are determined with the facilitation of one or more machine learning algorithms in real time. Furthermore, the one or more available vehicles from the plurality of transport vehicles are prioritized with the facilitation of the one or more machine learning algorithms in real time. Furthermore, notification of the allocation confirmation associated with the at least one selected vehicle from the one or more available vehicles is displayed in real time on the one or more media devices. Moreover, the at least one vendor from the one or more vendors is notified on the one or more media devices.

### BRIEF DESCRIPTION OF DRAWINGS

Having thus described the invention in general terms, references will now be made to the accompanying figures, wherein:

FIG. 1 illustrates an interactive computing environment for enabling an automated decision on selection of a plurality of transport vehicles associated with one or more vendors for long-haul route, in accordance with various embodiments of the present disclosure;

FIGS. 2A and 2B illustrate a flow chart of a method for enabling the automated decision on selection of the plurality of transport vehicles associated with the one or more vendors for long-haul route, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

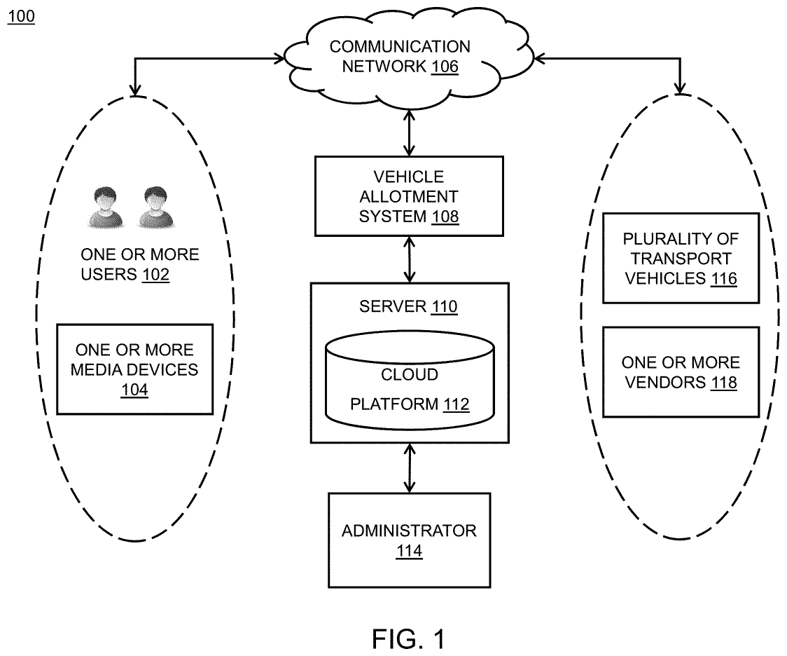

FIG. 1 illustrates an interactive computing environment 100 for an automated decision on selection of a plurality of transport vehicles 116 associated with one or more vendors 108 for long-haul route, in accordance with various embodiments of the present disclosure. The interactive computing environment 100 shows a relationship between various entities involved in selection of the plurality of transport vehicles 116 for the long-haul route.

The interactive computing environment 100 includes one or more users 102, one or more media devices 104, a communication network 106 and an vehicle allotment system 108. In addition, the interactive computing environment 100 includes a server 110, a cloud platform 112, an administrator 114, the plurality of transport vehicles 116, and one or more vendors 118. The above-stated elements of the interactive computing environment 100 operate coherently and synchronously. In an embodiment of the present disclosure, the interactive computing environment 100 is configured to provide a setup for the automated decision on selection of the transport vehicle for the long-haul route.

The interactive computing environment 100 is associated with the one or more users 102. The one or more users 102 may be any person or an individual looking for transportation assistance for plurality of products. In addition, the one or more users 102 may be any person or an individual looking for transportation assistance for long-haul route. In an embodiment of the present disclosure, the one or more users 102 are associated with the one or more media devices 104. In another example, the one or more users 102 are an owner of the one or more media devices 104. In another example, the one or more users 102 may not be the owner of the one or more media devices 104. In another embodiment of the present disclosure, the one or more users 102 may be a person who wants an assistance of services from the vehicle allotment system 108. In yet another embodiment of the present disclosure, the one or more users 102 may be any person. In yet another example, user x wants to transport 1000 kg of products with transportation help, the user x can get a perfect match for the one or more vendors 118 on his/her requirement. In yet another embodiment of the present disclosure, the one or more users 102 may interact with the vehicle allotment system 108 directly through the one or more media devices 104. In some cases, the one or more users 102 may interact with the vehicle allotment system 108 via the one or more media devices 104 through the communication network 106.

Further, the communication network 106 denotes to channels of communication (networks by which information flows). Small networks, which are used for connection to the subgroup and are usually contained in a piece of equipment. The local area network, or LAN, cable or fiber, is used to connect computer equipment and other terminals distributed in the local area, such as in the college campus. The Metropolitan Area Network or MAN is a high-speed network that is used to connect a small geographical area such as a LAN across the city. Wide area networks, or any communication connections, including WAN, microwave radio link and satellite, are used to connect computers and other terminals to a larger geographic distance. In yet another embodiment of the present disclosure, the communication network 106 may be any type of network that provides internet connectivity to the vehicle allotment system 108. In yet embodiment of the present disclosure, the communication network 106 is a wireless mobile network. In yet embodiment of the present disclosure, the communication network 106 is a wired network with finite bandwidth. In yet another embodiment of the present disclosure, the communication network 106 is a combination of the wireless and the wired network for optimum throughput of data transmission. In yet another embodiment of the present disclosure, the communication network 106 is an optical fiber high bandwidth network that enables high data rate with negligible connection drops. In yet another embodiment of the present disclosure, the communication network 106 provides medium for the one or more media devices 104 to connect to the vehicle allotment system 108. In this scenario, the communication network 106 may be a global network of computing devices such as the Internet.

The interactive computing environment 100 includes the one or more media devices 104. Commonly, media devices refer to equipment or device capable of transmitting analog or digital signals through communication wire or remote way. The best case of the media device is a PC modem, which is equipped for sending and getting analog or digital signals to enable PCs to converse with different PCs. In an embodiment of the present disclosure, the one or more media devices 104 includes a computer, laptop, smart television, PDA, electronic tablet, smartphone, wearable devices, tablet, smartwatch, smart display, gesture-controlled devices, and the like. In an example, the one or more media devices 104 displays, reads, transmits and gives output to the one or more users 102 in real time. The one or more users 102 may access the one or more media devices 104 while moving from one place to another place. In another example, the place includes home, park, restaurant, any facility, college, office and the like. In addition, the one or more users 102 may access the one or more media devices 104 from inside and outside of the environment.

In general, media devices are used for one or more purposes. In an example, the one or more purposes include communication, entertainment, accessing web-based platforms for different tasks and the like. In an embodiment of the present disclosure, the one or more media devices 104 includes a mobile application. The mobile application is installed on the one or more media devices 104. In general, the mobile application performs various tasks such as handling notifications and connectivity. Also, the mobile application is programmed in different languages for different platforms. Moreover, the use of the mobile application in online mode and offline mode depends on the type of application used. In an example, the mobile applications are used for entertaining, productivity, marketing and accessing various e-commerce and web-based platforms.

In addition, the one or more media devices 104 are associated with a camera, a global positioning system, keypad, touchscreen, and the like. The keypad gathers manual data input from the one or more users 102. In another embodiment of the present disclosure, the one or more media devices 104 are connected to the vehicle allotment system 108 with the facilitation of the communication network 106.

In an embodiment of the present disclosure, the one or more media devices 104 are connected to the internet in real time. Further, the one or more media devices 104 is associated with a specific type of operating system. The specific type of operating system includes an android operating system, a windows operating system, a mac operating system and the like. Moreover, the one or more media devices 104 are connected to the internet through the communication network 106. Further, the one or more media devices 104 are connected to the internet through a data connection provided by a telecom service provider. The telecom service provider is associated with a subscriber identification module card located inside the one or more media devices 104. Furthermore, the one or more media devices 104 may be connected to the internet through a WiFi connection.

In an embodiment of the present disclosure, the one or more media devices 104 is associated with the vehicle allotment system 108. In addition, the one or more media devices 104 is associated with the vehicle allotment system 108 through the communication network 106 to gain access to the internet. Moreover, the one or more media devices 104 provide a medium for transferring information between the one or more media devices 104 and the vehicle allotment system 108. Further, the medium for communication may be infrared, microwave, radio frequency (RF) and the like.

The interactive computing environment 100 includes the vehicle allotment system 108. The vehicle allotment system 108 enables integration between the one or more users 102, the one or more vendors 118, the administrator 114 and the plurality of transport vehicles 116. In an embodiment of the present disclosure, the vehicle allotment system 108 performs one or more steps for selection of one or more available vehicle from the plurality of transport vehicles 116. Also, the vehicle allotment system 108 performs the one or more steps to facilitate the one or more users 102 to select the suitable option from the one or more available vehicle on the vehicle allotment system 108 in real time. In another embodiment of the present disclosure, the vehicle allotment system 108 may ask the one or more users 102 to provide one or more details associated with requirement for the transportation of the plurality of products.

In an embodiment of the present disclosure, the one or more users 102 provide a first set of data. In another embodiment of the present disclosure, the first set of data includes a type of products, type of truck required, number of products, pickup date, pickup time, pickup location, drop location, and the like.

The interactive computing environment 100 includes the plurality of transport vehicles 116. In general, transport vehicles refer to vehicles designed for transport of goods from one place to another. The transport vehicles have variety of payload capacity depending on size and requirement of the vehicles. The transport vehicles for variety of goods have different arrangement for carrying goods. In an embodiment of the present disclosure, the plurality of transport vehicles 116 includes single-axle truck, double-axle truck, tri-axle truck, quad-axle truck, bus, train, aircraft, two-wheeler, three-wheeler, trailer truck, transporter truck and mini-truck, and the like.

The interactive computing environment 100 includes the one or more vendors 118. In general, vendor refers to an enterprise that contributes goods or services. In addition, the vendor denotes to a supplier of any good or service. In an embodiment of the present disclosure, the one or more vendors 118 transport the plurality of products from one place to another. In another embodiment of the present disclosure, the one or more vendors 118 bid for transportation of the plurality of products from one place to another. In yet another embodiment of the present disclosure, the one or more vendors 118 owns the plurality of transport vehicles 116. In yet another embodiment of the present disclosure, the one or more vendors 118 are associated with the vehicle allotment system 108 with the facilitation of the communication network 106.

The interactive computing environment 100 includes the administrator 114. In general, administrator refers to a person who ensures that an organization operates efficiently. The administrator 114 performs specific duties depending on type of company, organization, or entity where the administrator 114 works. In an embodiment of the present disclosure, the administrator 114 defines predefined rules. In an embodiment of the present disclosure, the administrator 114 modifies predefined rules in real time. The predefined rules are stored on the cloud platform 112. In another embodiment of the present disclosure, the administrator 114 can see at least one selected vehicle for the long-haul route. In yet another embodiment of the present disclosure, the administrator 114 can change the at least one selected vehicle for the long-haul route.

The interactive computing environment 100 includes the server 110. In an embodiment of the present disclosure, the vehicle allotment system 108 is associated with the server 110. In another embodiment of the present disclosure, the one or more vendors 118 is associated with the server 110. In yet another embodiment of the present disclosure, the vehicle allotment system 108 is installed at the server 110. In yet another embodiment of the present disclosure, the vehicle allotment system 108 is installed at a plurality of servers. In general, a server refers to a computer that provides data to other computers. It may serve data to systems on a local area network (LAN) or a wide area network (WAN) over the Internet. Many types of servers exist, including web servers, mail servers, file servers, and the like. Each type of server runs software specific to the purpose of the server. For example, a Web server may run Apache HTTP Server or Microsoft IIS, which both provide access to websites over the Internet. A mail server may run a program like Exim or I Mail, which provides SMTP services for sending and receiving the email. A file server might use Samba or the operating system's built-in file sharing services to share files over a network. While server software is specific to the type of server, the hardware is not as important. In fact, a regular desktop computer can be turned into a server by adding the appropriate software. For example, a computer connected to a home network can be designated as a file server, print server, or both. In another example, the plurality of servers may include a database server, file server, application server and the like. The plurality of servers communicates with each other using the communication network 106.

In an embodiment of the present disclosure, the vehicle allotment system 108 is located in the server 110. In yet another embodiment of the present disclosure, the vehicle allotment system 108 is connected with the server 110. In yet another embodiment of the present disclosure, the server 110 is a part of the vehicle allotment system 108. In an embodiment of the present disclosure, the server 110 receives data from the cloud platform 112.

The interactive computing environment 100 includes the cloud platform 112. In general, a cloud platform refers to a data structure that stores organized information. Most cloud platforms contain multiple tables, which may each include several different fields. For example, the cloud platform 112 may include records related to interest of the one or more users 102, the first set of data, a second set of data, performance history of the one or more vendors 118, maintenance history of the plurality of transport vehicles 116, and the like. Each of these tables would have different fields that are relevant to the information stored in the table. In another embodiment of the present disclosure, the data available on the one or more web-based platforms is the data filled by the one or more users 102 in past time. In an example, the one or more users 102 updates the data on the one or more web-based platforms on a regular basis. Thus, the vehicle allotment system 108 authenticates the first set of data after receiving the first set of data from the one or more users 102. In yet another embodiment of the present disclosure, data stored on the cloud platform 112 is used for the analysis of the user preferences, user behaviour, and the like.

In an embodiment of the present disclosure, the second set of data includes technical parameters and general parameters associated with the plurality of transport vehicles 116 and the one or more vendors 118. In addition, the technical parameters include fuel consumption of vehicle, vehicle health, load carrying capacity of vehicle, type of vehicle, length of vehicle, range of vehicle, engine capacity of vehicle, and the like. Further, the general parameters include vehicles on same route, current schedule, current availability, future availability on the requested date, current location, remaining distance, current estimated time of arrival, number of pitstops, duration of pitstops, distance between pickup location, destination point of previous trip of the current vehicles in transit, and the like. Furthermore, the second set of data is fetched from a plurality of databases in real time. The plurality of databases includes vendor records, google records, bing.com records, and the like. In yet another embodiment of the present disclosure, the plurality of databases includes financial information of the one or more users 102. In yet another embodiment of the present disclosure, the plurality of databases includes performance details of the one or more vendors 118.

In an embodiment of the present disclosure, the vehicle allotment system 108 receives a request for the one or more transport vehicles for transportation on the long-haul route. The request for the one or more transport vehicles is based on the first set of data. In addition, the first set of data is received from the one or more users 102 with the facilitation of the one or more media devices 104 in real time. Further, the vehicle allotment system 108 fetches the second set of data from the cloud platform 112. Furthermore, the second set of data is associated with the plurality of transport vehicles 116.

In an embodiment of the present disclosure, the vehicle allotment system 108 analysis the first set of data and the second set of data. In addition, the first set of data and the second set of data are analysed in real time. Further, the decision allotment system 108 determines one or more available vehicles from the plurality of transport vehicles 116 in real time. The one or more available vehicles from the plurality of transport vehicles 116 are determined with the facilitation of one or more machine learning algorithms in real time. The one or more machine learning algorithms includes linear regression, logistic regression, sum of vector machine, decision tree, random forest, KNN function, and the like.

In addition, the vehicle allotment system 108 prioritizes the one or more available vehicles from the plurality of transport vehicles 116 based on score card of the plurality of transport vehicles 116 and the one or more vendors 118. The one or more available vehicles from the plurality of transport vehicles 116 is prioritized with the facilitation of the one or more machine learning algorithms in real time. Further, the score card of the plurality of transport vehicles 116 and the one or more vendors 118 are determined based on the past services offered by the one or more vendors 118, interaction with the one or more vendors 118, commitment by the one or more vendors 118, condition of vehicles offered by the one or more vendors 118, past profitability ratio on hiring the one or more vendors 118, and the like.

Further, the vehicle allotment system 108 sends an allocation confirmation to the one or more users 102 for the at least one selected vehicle from the one or more available vehicles. Furthermore, notification of the allocation confirmation from the one or more available vehicles is displayed in real time on the one or more media devices 104. The allocation confirmation is associated with the at least one selected vehicle. Moreover, the vehicle allotment system 108 notifies to at least one vendor of the one or more vendors 118 for the transportation of the plurality of products on the long-haul route. Also, the one or more vendors 118 is associated with the at least one selected vehicle from the plurality of transport vehicles 116. The at least one vendor from the one or more vendors 118 is notified on the one or more media devices 104.

In an embodiment of the present disclosure, the vehicle allotment system 108 alerts the administrator 114 for selection of the at least one vendor of the one or more vendors 118 for the transportation of the plurality of products on the long-haul route. The at least one vendor is associated with the at least one selected vehicle from the plurality of transport vehicles 116. In addition, the administrator 114 is notified on the one or more media devices 104. Further, the administrator 114 modifies the selection of the at least one vendor of the one or more vendors 118 for the transportation of the plurality of products on the long-haul route.

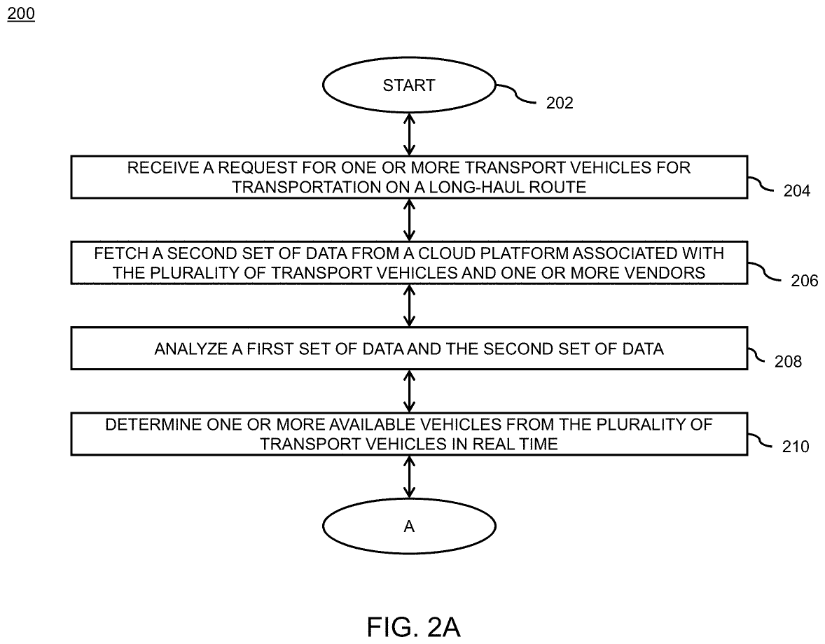

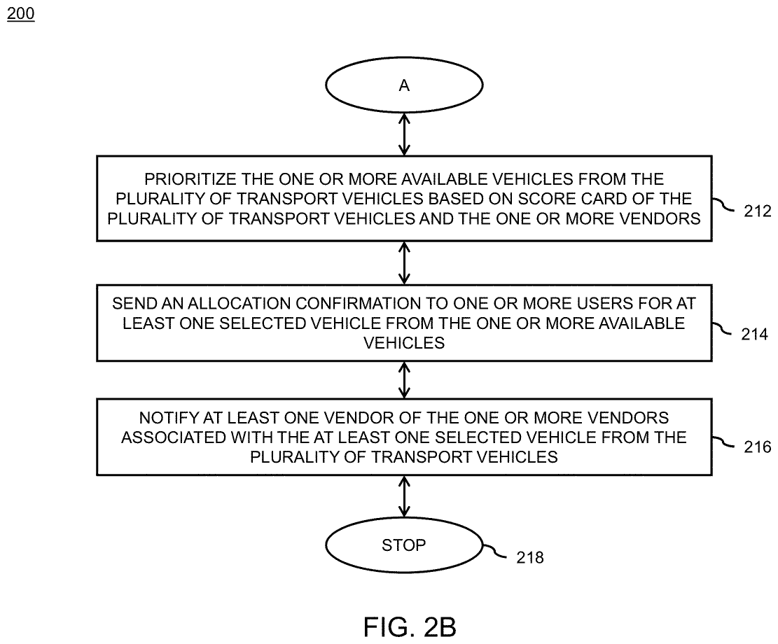

FIGS. 2A and 2B illustrate a flow chart of a method for enabling the automated decision on the selection of the plurality of transport vehicles associated with the one or more vendors for long haul route, in accordance with various embodiments of the present disclosure. It may be noted that to explain the process steps of flowchart 200, references will be made to the system elements of FIG. 1. It may also be noted that the flowchart 200 may have lesser or more number of steps.

The flow chart 200 initiates at step 202. Following step 202, at step 204, the vehicle allotment system 108 receives the request for the one or more transport vehicles for transportation on the long-haul route. Following step 204, at step 206, the vehicle allotment system 108 fetches the second set of data from the cloud platform. The second set of data is associated with the plurality of transport vehicles 116 and the one or more vendors 118. Following step 206, at step 208, the vehicle allotment system 108 analyzes the first set of data and the second set of data. The first set of data and the second set of data are analyzed in real time. Following step 208, at step 210, the vehicle allotment system 108 determines the one or more available vehicles from the plurality of transport vehicles 116 in real time. Following step 210, at step 212, the vehicle allotment system 108 prioritizes the one or more available vehicles from the plurality of transport vehicles 116 based on the score card of the plurality of transport vehicles 116 and the one or more vendors 118. Following step 212, at step 214, the vehicle allotment system 108 sends the allocation confirmation to the one or more users 102 for the at least one selected vehicle from the one or more available vehicles. Following step 214, at step 216, the vehicle allotment system 108 notifies the at least one vendor of the one or more vendors associated with the at least one selected vehicle from the plurality of transport vehicles 116 for the transportation of the plurality of products on the long-haul route.

The flow chart 200 terminates at step 218. It may be noted that the flowchart 200 is explained to have above stated process steps; however, those skilled in the art would appreciate that the flowchart 200 may have more/less number of process steps which may enable all the above stated embodiments of the present disclosure.

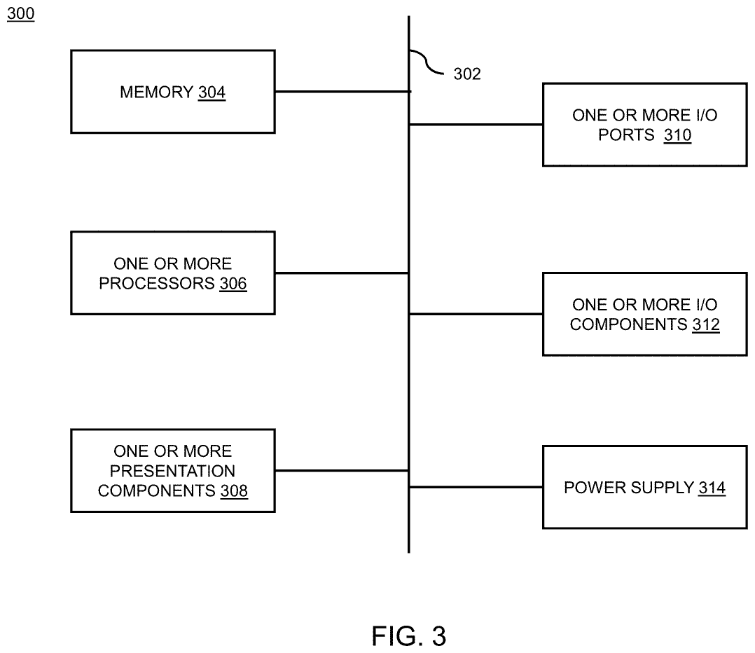

FIG. 3 illustrates a block diagram of a computing device 300, in accordance with various embodiments of the present disclosure. In an embodiment of the present disclosure, the computing device 300 illustrates hardware elements of each communication device of the communication devices 104. The computing device 300 is a non-transitory computer readable storage medium. The computing device 300 includes a bus 302 that directly or indirectly couples the following devices: memory 304, one or more processors 206, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any system or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes one or more processors that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device and the like.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for an automated decision on selection of a plurality of transport vehicles associated with one or more vendors for long haul route, the computer-implemented method comprising:
receiving, at a vehicle allotment system with a processor, a request for the plurality of transport vehicles for transportation on the long-haul route, wherein the request for the one or more transport vehicles is based on a first set of data, wherein the first set of data is received from one or more users with facilitation of one or more media devices in real time;
fetching, at the vehicle allotment system with the processor, a second set of data from a cloud platform, wherein the second set of data is associated with a plurality of transport vehicles and the one or more vendors;
analyzing, at the vehicle allotment system with the processor, the first set of data and the second set of data, wherein the first set of data and the second set of data are analyzed in real time;
determining, at the vehicle allotment system with the processor, one or more available vehicles from the plurality of transport vehicles in real time, wherein the one or more available vehicles from the plurality of transport vehicles is determined with facilitation of one or more machine learning algorithms in real time;
prioritizing, at the vehicle allotment system with the processor, the one or more available vehicles from the plurality of transport vehicles based on score card of the plurality of transport vehicles and the one or more vendors, wherein the one or more available vehicles from the plurality of transport vehicles is prioritized with facilitation of the one or more machine learning algorithms in real time;
sending, at the vehicle allotment system with the processor, an allocation confirmation to the one or more users for at least one selected vehicle from the one or more available vehicles, wherein notification of the allocation confirmation associated with the at least one selected vehicle from the one or more available vehicles is displayed in real time on the one or more media devices; and
notifying, at the vehicle allotment system with the processor, to at least one vendor of the one or more vendors associated with the at least one selected vehicle from the plurality of transport vehicles for transportation of the plurality of products on the long-haul route, wherein the at least one vendor from the one or more vendors is notified on the one or more media devices.

2. The computer-implemented method as recited in claim 1, wherein the first set of data comprising type of products, type of truck required, number of products, pickup date, pickup time, pickup location, and drop location.

3. The computer-implemented method as recited in claim 1, wherein the second set of data comprising technical parameters and general parameters associated with the plurality of transport vehicles and the one or more vendors.

4. The computer-implemented method as recited in claim 3, wherein the technical parameters comprising fuel consumption of vehicle, vehicle health, load carrying capacity of vehicle, type of vehicle, length of vehicle, range of vehicle, and engine capacity of vehicle.

5. The computer-implemented method as recited in claim 3, wherein the general parameters comprising vehicles on same route, current schedule, current availability, future availability on the requested date, current location, remaining distance, current estimated time of arrival, number of pitstops, duration of pitstops, distance between pickup location and destination point of previous trip of the current vehicles in transit.

6. The computer-implemented method as recited in claim 1, wherein the score card of the plurality of transport vehicles and the one or more vendors are determined based on the past services offered by the one or more vendors, interaction with the one or more vendors, commitment by the one or more vendors, condition of vehicles offered by the one or more vendors and past profitability ratio on hiring the one or more vendors.

7. The computer-implemented method as recited in claim 1, further comprising alerting, at the vehicle allotment system with the processor, an administrator for selection of the at least one vendor of the one or more vendors associated with the at least one selected vehicle from the plurality of transport vehicles for the transportation of the plurality of products on the long-haul route, wherein the administrator is notified on the one or more media devices.

8. The computer-implemented method as recited in claim 7, wherein the administrator modifies selection of the at least one vendor of the one or more vendors associated with the at least one selected vehicle from the plurality of transport vehicles for the transportation of the plurality of products on the long-haul route.

9. A computer system comprising:
one or more processors; and
a memory coupled to the one or more processors, the memory for storing instructions which, when executed by the one or more processors, cause the one or more processors to perform a method for an automated decision on selection of a plurality of transport vehicles associated with one or more vendors for long haul route, the method comprising:
receiving, at an vehicle allotment system, a request for the plurality of transport vehicles for transportation on the long-haul route, wherein the request for the one or more transport vehicles is based on a first set of data, wherein the first set of data is received from one or more users with facilitation of one or more media devices in real time;
fetching, at the vehicle allotment system, a second set of data from a cloud platform, wherein the second set of data is associated with a plurality of transport vehicles and the one or more vendors;
analyzing, at the vehicle allotment system, the first set of data and the second set of data, wherein the first set of data and the second set of data are analyzed in real time;
determining, at the vehicle allotment system, one or more available vehicles from the plurality of transport vehicles in real time, wherein the one or more available vehicles from the plurality of transport vehicles is determined with facilitation of one or more machine learning algorithms in real time;
prioritizing, at the vehicle allotment system, the one or more available vehicles from the plurality of transport vehicles based on score card of the plurality of transport vehicles and the one or more vendors, wherein the one or more available vehicles from the plurality of transport vehicles is prioritized with facilitation of the one or more machine learning algorithms in real time;
sending, at the vehicle allotment system, an allocation confirmation to the one or more users for at least one selected vehicle from the one or more available vehicles, wherein notification of the allocation confirmation associated with the at least one selected vehicle from the one or more available vehicles is displayed in real time on the one or more media devices; and
notifying, at the vehicle allotment system, to at least one vendor of the one or more vendors associated with the at least one selected vehicle from the plurality of transport vehicles for transportation of the plurality of products on the long-haul route, wherein the at least one vendor from the one or more vendors is notified on the one or more media devices.

10. The computer system as recited in claim 9, wherein the first set of data comprising type of products, type of truck required, number of products, pickup date, pickup time, pickup location, and drop location.

11. The computer system as recited in claim 9, wherein the second set of data comprising technical parameters and general parameters associated with the plurality of transport vehicles and the one or more vendors.

12. The computer system as recited in claim 11, wherein the technical parameters comprising fuel consumption of vehicle, vehicle health, load carrying capacity of vehicle, type of vehicle, length of vehicle, range of vehicle, and engine capacity of vehicle.

13. The computer system as recited in claim 11, wherein the general parameters comprising vehicles on same route, current schedule, current availability, future availability on the requested date, current location, remaining distance, current estimated time of arrival, number of pitstops, duration of pitstops, distance between pickup location and destination point of previous trip of the current vehicles in transit.

14. The computer system as recited in claim 9, wherein the score card of the plurality of transport vehicles and the one or more vendors are determined based on the past services offered by the one or more vendors, interaction with the one or more vendors, commitment by the one or more vendors, condition of vehicles offered by the one or more vendors and past profitability ratio on hiring the one or more vendors.

15. The computer system as recited in claim 1, further comprising alerting, at the vehicle allotment system, an administrator for selection of the at least one vendor of the one or more vendors associated with the at least one selected vehicle from the plurality of transport vehicles for the transportation of the plurality of products on the long-haul route, wherein the administrator is notified on the one or more media devices.

16. The computer system as recited in claim 15, wherein the administrator modifies the selection of the at least one vendor of the one or more vendors associated with the at least one selected vehicle from the plurality of transport vehicles for the transportation of the plurality of products on the long-haul route.

17. A non-transitory computer-readable storage medium encoding computer executable instructions that, when executed by at least one processor, performs a method for an automated decision on selection of a plurality of transport vehicles associated with one or more vendors for long haul route, the method comprising:
receiving, at a computing device, a request for the plurality of transport vehicles for transportation on the long-haul route, wherein the request for the one or more transport vehicles is based on a first set of data, wherein the first set of data is received from one or more users with facilitation of one or more media devices in real time;
fetching, at the computing device, a second set of data from a cloud platform, wherein the second set of data is associated with a plurality of transport vehicles and the one or more vendors;
analyzing, at the computing device, the first set of data and the second set of data, wherein the first set of data and the second set of data are analyzed in real time;
determining, at the computing device, one or more available vehicles from the plurality of transport vehicles in real time, wherein the one or more available vehicles from the plurality of transport vehicles is determined with facilitation of one or more machine learning algorithms in real time;
prioritizing, at the computing device, the one or more available vehicles from the plurality of transport vehicles based on score card of the plurality of transport vehicles and the one or more vendors, wherein the one or more available vehicles from the plurality of transport vehicles is prioritized with facilitation of the one or more machine learning algorithms in real time;
sending, at the computing device, an allocation confirmation to the one or more users for at least one selected vehicle from the one or more available vehicles, wherein notification of the allocation confirmation associated with the at least one selected vehicle from the one or more available vehicles is displayed in real time on the one or more media devices; and
notifying, at the computing device, to at least one vendor of the one or more vendors associated with the at least one selected vehicle from the plurality of transport vehicles for the transportation of the plurality of products on the long-haul route, wherein the at least one vendor from the one or more vendors is notified on the one or more media devices.

18. The non-transitory computer-readable storage medium as recited in claim 17, wherein the first set of data comprising a type of products, type of truck required, number of products, pickup date, pickup time, pickup location, and drop location.

19. The non-transitory computer-readable storage medium as recited in claim 1, wherein the second set of data comprising technical parameters and general parameters associated with the plurality of transport vehicles and the one or more vendors.

20. The non-transitory computer-readable storage medium as recited in claim 19, wherein the technical parameters comprising fuel consumption of vehicle, vehicle health, load carrying capacity of vehicle, type of vehicle, length of vehicle, range of vehicle, and engine capacity of vehicle.
